(19) United States
(12) Patent Application Publication
(10) Pub. No.: US 2026/0162422 A1
(43) Pub. Date: Jun. 11, 2026

(54) OBJECT DETECTION DEVICE AND METHOD

(71) Applicants: HYUNDAI MOTOR COMPANY, Seoul (KR); KIA CORPORATION, Seoul (KR)

(72) Inventors: Hyun Jun Kim, Hwaseong-si (KR); Jung Phil Kwon, Hwaseong-si (KR)

(73) Assignees: HYUNDAI MOTOR COMPANY, Seoul (KR); KIA CORPORATION, Seoul (KR)

(21) Appl. No.: 19/227,115

(22) Filed: Jun. 3, 2025

(30) Foreign Application Priority Data
Dec. 6, 2024 (KR) 10-2024-0180075

(51) Int. Cl. G06V 10/98; G06T 7/292; G06V 10/12; G06V 20/58

(52) U.S. Cl. CPC G06V 10/98; G06T 7/292; G06V 10/12; G06V 20/58; G06T 2207/30261

(57) ABSTRACT

An object detection device including one or more processors and a memory storing computer-readable instructions executable by the one or more processors. The one or more processors are configured to detect an object in first image data captured by a first camera to determine a first measurement value and detect the object in second image data captured by a second camera to determine a second measurement value. The one or more processors are also configured to estimate movement of the object from the first image data and the second image data to determine a state estimation value. The one or more processors are further configured to determine a third measurement value based on the first measurement value and the second measurement value. The one or more processors are additionally configured to update the state estimation value by reflecting the third measurement value in the state estimation value.

### CROSS-REFERENCE TO RELATED APPLICATION

This application claims priority to and the benefit of Korean Patent Application No. 10-2024-0180075, filed on Dec. 6, 2024, the entire contents of which are hereby incorporated herein by reference.

### BACKGROUND

### 1. Technical Field

The present disclosure relates to an object detection device and method.

### 2. Discussion of Related Art

In recent years, as the number of cameras mounted on a vehicle increases, there is a problem that the fields of view of multiple cameras overlap each other. In general, the multi-camera system uses a sensor fusion method to combine data from individual cameras.

However, when the same object is detected by multiple cameras, multiple estimation values of a location and shape of the object are generated, which may cause confusion in recognition results. In particular, when duplicated estimation values are not handled, object detection accuracy may be decreased and the performance of the system may be adversely affected.

In existing technologies, the Kalman Filter has been used to handle these duplicate estimation values, but in the conventional Kalman Filter application method, in many cases, the covariance of estimation values has been set to a constant value. This leads to a problem in that the uncertainty or tendency of network output is not reflected, and there is a limit to the estimation of the depth of the object according to the confidence of the estimation values. As a result, existing technologies do not fully utilize the confidence of the estimation values provided by the network, and thus, there is a problem of making it difficult to improve the accuracy of location and distance estimation.

### SUMMARY

Embodiments of the present disclosure provide an object detection device and method capable of solving a duplication problem of object recognition in a multi-camera system.

Embodiments of the present disclosure provide an object detection device and method capable of significantly improving the accuracy of location and depth estimation of an object through a technology that dynamically adjusts estimation values by reflecting the characteristics of a trained network.

The technical problems to be solved by the present disclosure are not limited to the aforementioned problems. Other technical problems not mentioned herein should be more clearly understood from the following description by those having ordinary skill in the art to which the present disclosure pertains.

According to an aspect of the present disclosure, an object detection device is provided. The object detection device includes one or more processors and a memory storing one or more computer-readable instructions executable by the one or more processors. The one or more processors are configured to detect an object in first image data captured by a first camera to determine a first measurement value, and detect the object in second image data captured by a second camera to determine a second measurement value. The one or more processors are also configured to estimate movement of the object from the first image data and the second image data to determine a state estimation value. The one or more processors are further configured to determine a third measurement value based on the first measurement value and the second measurement value. The one or more processors are additionally configured to update the state estimation value by reflecting the third measurement value in the state estimation value.

The one or more processors may be configured to determine the state estimation value by reflecting movement of a host vehicle.

The one or more processors may be configured to compare the first measurement value and the second measurement value with the state estimation value to determine whether there is a match, and determine the third measurement value using at least one of the first measurement value and the second measurement value that is matched.

The one or more processors may be configured to compare the first measurement value and the second measurement value with the state estimation value using a Hungarian algorithm to determine whether there is a match.

The first measurement value and the second measurement value may include probability information that the object is present at specific coordinates and distance information.

The one or more processors may be configured to determine normal distributions of the first measurement value and the second measurement value and determine the third measurement value by integrating the normal distributions.

The one or more processors may be configured to determine the third measurement value by reflecting weights in the first measurement value and the second measurement value according to the probability information.

The one or more processors may be configured to reflect the weights in the first measurement value and the second measurement value in proportion to a probability value of the probability information.

The one or more processors may be configured to initialize the distance information using a variance of the probability information and the distance information.

The one or more processors may be configured to compare the first measurement value and the second measurement value in which the distance information is initialized with the state estimation value to determine whether there is a match, and determine the third measurement value using at least one of the first measurement value and the second measurement value that is matched.

According to another aspect of the present disclosure, a method of detecting an object is provided. The method includes detecting, by a processor, an object in first image data captured by a first camera to determine a first measurement value. The method also includes detecting, by the processor, the object in second image data captured by a second camera to determine a second measurement value. The method additionally includes estimating, by the processor, movement of the object from the first image data and the second image data to determine a state estimation value. The method further includes determining, by the processor, a third measurement value based on the first measurement value and the second measurement value. The method additionally includes reflecting, by the processor, the third measurement value in the state estimation value to update the state estimation value.

Determining the state estimation value may include reflecting movement of a host vehicle.

Determining the third measurement value may include comparing the first measurement value and second measurement value with the state estimation value to determine whether there is a match and determining the third measurement value using at least one of the first measurement value and the second measurement value that is matched.

Determining whether there is a match may include comparing the first measurement value and the second measurement value with the state estimation value using a Hungarian algorithm.

The first measurement value and the second measurement value may include probability information that the object is present at specific coordinates and distance information.

Determining the third measurement value may include determining normal distributions of the first measurement value and the second measurement value and determining the third measurement value by integrating the normal distributions.

Determining the third measurement value may include determining the third measurement value by reflecting weights in the first measurement value and the second measurement value according to the probability information.

Determining the third measurement value may include reflecting the weights in the first measurement value and the second measurement value in proportion to a probability value of the probability information.

Determining the third measurement value may include initializing the distance information using a variance of the probability information and the distance information.

Determining the third measurement value may include comparing the first measurement value and second measurement value in which the distance information is initialized with the state estimation value to determine whether there is a match and determining the third measurement value using at least one of the first measurement value and the second measurement value that is matched.

### BRIEF DESCRIPTION OF THE DRAWINGS

The above and other objects, features, and advantages of the present disclosure should become more apparent to those of ordinary skill in the art from the following detailed description taken in conjunction with the accompanying drawings, in which:

FIG. 1 is a view showing a vehicle transmitting and receiving data by communicating with other devices, according to an embodiment of the present disclosure;

FIG. 2 is a diagram showing modules of a vehicle, according to an embodiment of the present disclosure;

FIG. 3 is a diagram for describing the operation of an object detection device, according to an embodiment of the present disclosure;

FIGS. 4-7 are views for describing the operation of a processor, according to an embodiment of the present disclosure; and

FIG. 8 is a flowchart of a method of detecting an object, according to an embodiment of the present disclosure.

### DETAILED DESCRIPTION

Hereinafter, embodiments of the present disclosure are described in detail with reference to the accompanying drawings. However, the technical idea of the present disclosure is not limited to the described embodiments. Rather, the present disclosure may be implemented in various different forms. For example, within the scope of the technical idea of the present disclosure, one or more components in the described embodiments may be selectively combined and/or substituted.

Further, unless specifically defined and described herein, terms used in the following description (including technical and scientific terms) should be interpreted as having meanings generally understood by those having ordinary skill in the art to which the present disclosure pertains, and commonly used terms such as terms defined in dictionaries should be interpreted in consideration of the contextual meaning of the related art.

The terms used in the following description are for the purpose of describing the embodiments only and are not intended to limit the present disclosure.

In the present specification, the singular forms include the plural forms unless the context clearly dictates otherwise, and when described as “at least one (or one or more) among A, B, and (or) C,” it may include one or more of all possible combinations of A, B, and/or C.

In addition, when describing components of embodiments of the present disclosure, terms such as first, second, A, B, (a), (b), etc., may be used. These terms are only for distinguishing the components from other components, and the essence, sequence, or order of the components is not limited by these terms.

In addition, when a component is described as being “linked,” “coupled,” or “connected” to or with another component, the component is not necessarily directly linked, coupled, or connected to or with the other component, but may also be “linked,” “coupled,” or “connected” to or with the other component with one or more still other components disposed between the component and the other component.

Further, when a component is described as being formed or disposed “on (above) or under (below)” another component, the term “on (above) or under (below)” includes not only when two components are in direct contact with each other, but also when one or more other components are formed or disposed between the two components. Further, when a component is described as being “on (above) or below (under),” the description may include the meanings of an upward direction and a downward direction based on one component.

In the present disclosure, when a component, controller, device, element, apparatus, unit or the like of the present disclosure is described as having a purpose or performing an operation, function, or the like, the component, controller, device, element, apparatus, unit or the like should be considered herein as being “configured to” meet that purpose or to perform that operation or function. Each component, controller, device, element, apparatus, unit, and the like may separately embody or be included with a processor and a memory, such as a non-transitory computer readable media, as part of the apparatus.

Hereinafter, embodiments of the present disclosure are described in detail with reference to the accompanying drawings. In the following description, the same or corresponding components are denoted by the same reference numerals regardless of the drawing numbers, and redundant descriptions thereof are omitted.

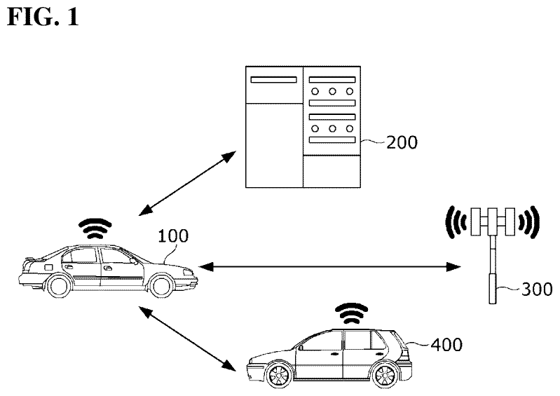

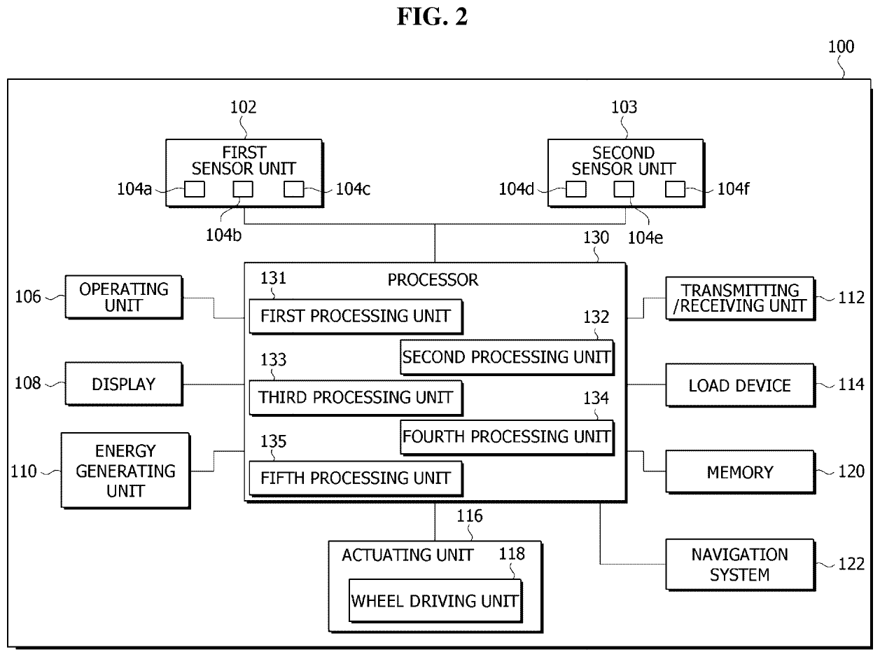

Hereinafter, a vehicle according to an embodiment is described in detail with reference to FIGS. 1 and 2. FIG. 1 is a view illustrating a vehicle transmitting and receiving data by communicating with other devices, according to an embodiment.

Referring to FIG. 1, a vehicle 100 may be driven based on electrical energy or fossil energy. In the case of electrical energy, the vehicle 100 may be, for example, a pure battery-based vehicle driven only by a high-voltage battery, or may employ a gas-based fuel cell as an energy source. In addition, the fuel cell may use various types of gas capable of generating electrical energy. The vehicle 100 may be filled with gas in a liquefied state, for example. One example of the gas may be hydrogen. However, the gas is not limited thereto, and various gases are applicable. In the case of fossil energy, the vehicle 100 is driven based on fuel such as gasoline, diesel or liquefied gas, and may be equipped with an internal combustion engine that drives an actuating unit (e.g., actuation unit 116 of FIG. 2) by combustion of the fuel. The engine may be included in an energy generating unit 110 in terms of providing a driving rotational force of wheels to a wheel driving unit (e.g., wheel driving unit 118 of FIG. 2). As another example, the vehicle 100 may drive the actuating unit by selectively utilizing energy from a fossil energy-based internal combustion engine and an electric battery, and may be a hybrid type vehicle.

The vehicle 100 may refer to a movable device. The vehicle 100 may be a ground vehicle that travels on the ground and may be a typical passenger car, a commercial vehicle, a purpose-built vehicle (PBV), or the like. The vehicle 100 may be a four-wheeled vehicle, such as a passenger car, a sport utility vehicle (SUV), or a small truck, or may be a vehicle with more than four wheels, such as a bus, a large truck, a container transport vehicle, a heavy equipment vehicle, or the like. The ground vehicle may refer to any vehicle including a vehicle that moves underground as well as a vehicle that moves over 1and. The vehicle 100 may be a robot in a broad sense, such as a means of movement, and the robot may be moved using wheels, tracks, or other movement modules. In the present disclosure, ground mobility devices such as ground vehicles are mainly described, but unless it contradicts the present disclosure, the present embodiment may also be applied to air mobility devices such as AAMs, aircraft, or the like, and water mobility devices such as ships, submarines, or the like.

The vehicle 100 may be controlled and driven by autonomous driving, and the autonomous driving may be implemented as semi-autonomous driving or fully autonomous driving. Fully autonomous driving may be provided as autonomous movement in which a processor (e.g., processor 130 of FIG. 2) of the vehicle 100 takes full control without user intervention, even when a driving situation is uncertain. Semi-autonomous driving may be provided as autonomous movement that requires driver intervention depending on specific driving situations. The semi-autonomous driving may be implemented so that the processor transfers control to a user by deactivating autonomous driving when the aforementioned situation occurs, allowing the user to perform manual driving. According to the levels of autonomous driving defined by the Society of Automotive Engineers (SAE), the semi-autonomous driving may correspond to autonomous driving levels 1-4, and the fully autonomous driving may correspond to level 5.

The vehicle 100 may communicate with other devices 200 and 300 or another vehicle 400. Other devices may include, for example, a server 200 that supports various controls, state management, and driving of the vehicle 100, an intelligent transportation system (ITS) device 300 for receiving information from an ITS, various types of user devices, or the like. The server 200 may be, for example, an external device operated by a vehicle manufacturer or provided to service autonomous driving, and may receive connected data of the vehicle 100 and/or transmit data necessary for autonomous driving. The server 200 may transmit various information and software modules used to control the vehicle 100 to the vehicle 100 in response to requests and data transmitted from the vehicle 100 and the user device to support autonomous driving and various services of the vehicle 100.

The ITS device 300 may be, for example, a roadside unit (RSU), and the ITS device 300 may assist the user in driving his or her own vehicle or support autonomous driving of the vehicle 100 by exchanging vehicle recognition data, driving control and state data, environmental data around the vehicle, map data, or the like, through vehicle-to-infrastructure (V2I) communication with the vehicle 100. The vehicle 100 may support manual driving or autonomous driving by exchanging the data through vehicle-to-vehicle (V2V) communication with the other vehicle 400.

The vehicle 100 may communicate with other vehicles and/or other devices based on cellular communication, wireless access in vehicular environment (WAVE) communication, dedicated short range communication (DSRC), short-range communication, or other communication methods.

For example, the vehicle 100 may use a cellular communication network such as Long Term Evolution (LTE) or 5G, a WiFi communication network, a WAVE communication network, or the like, for communication with the server 200, the ITS device 300, and the other vehicle 400. For another example, Direct Short Range Communication (DSRC) or the like used in the vehicle 100 may be used for communication between vehicles. The communication method between the vehicle 100, the server 200, the ITS device 300, the other vehicle 400, and the user device is not limited to the above-described examples.

FIG. 2 is a diagram showing modules constituting the vehicle 100 of FIG. 1, according to an embodiment of the present disclosure.

The vehicle 100 may include a first sensor unit 102, a second sensor unit 103, an operating unit 106, a display 108, a load device 114, and a transmitting/receiving unit 112. The vehicle 100 may also include a memory 102 and the processor 130.

The first sensor unit 102 may be provided with various types of detectors to detect various states and situations occurring in an external environment, an internal system, user operation, and a boarding space of the vehicle 100.

In an embodiment, the first sensor unit 102 may be provided with an externally oriented camera 104a, a lidar sensor 104b, a radar sensor 104c, and the like, to recognize dynamic and static objects present outside the vehicle 100. The camera 104a may recognize an external object as an image while the vehicle 100 is in use, generate image data, and transmit the image data to the processor 130. The lidar sensor 104b may generate point cloud data as recognized data of the external object and transmit the point cloud data to the processor 130 to generate 3D spatial information that identifies at least a shape of the external object. In order to ascertain the presence of an external object and its relative distance, speed, direction, or the like, the radar sensor 104c may emit radio waves of a specific frequency around the vehicle 100 and generate radar data through radio waves reflected from the external object. In the present disclosure, the sensor unit is illustrated as having the lidar sensor 104b, but in other examples, the lidar sensor 104b may not be mounted.

The first sensor unit 102 may generate object recognition information based on sensing data. The object recognition information may include information on the presence of an object, position information about the object, information on a distance between the vehicle 100 and the object, and information on a relative speed between the vehicle 100 and the object. In the embodiment, external objects may be various objects related to the operation of the vehicle 100.

The second sensor unit 103 may be provided with a positioning sensor 104d, a wheel sensor 104e, an attitude sensor 104f, and the like, to confirm its own location, speed, driving attitude, and the like. The attitude sensor 104f may include a gyro sensor, an angular velocity sensor, an acceleration sensor, or the like. The attitude sensor may be an inertial measurement unit (IMU) sensor and may be equipped with a 3-axis accelerometer and a 3-axis gyroscope. The attitude sensor 104f may measure acceleration in a traveling direction (x), acceleration in a lateral direction (y), and acceleration in a height direction (z) of the vehicle 100, and a yaw, a pitch, and a roll as the angular velocity of the vehicle.

The second sensor unit 103 may generate vehicle driving information based on sensing data. The vehicle driving information may be information generated based on data detected by various sensors installed inside the vehicle. For example, the vehicle driving information may include vehicle attitude information, vehicle speed information, vehicle inclination information, vehicle weight information, vehicle direction information, vehicle battery information, vehicle fuel information, vehicle tire pressure information, vehicle steering information, vehicle interior temperature information, vehicle interior humidity information, pedal position information, vehicle engine temperature information, and the like.

In addition, the vehicle driving information may include route information. The route information may refer to information generated based on a destination input by a vehicle user through the operating unit 106. The route information may refer to information that indicates a traveling route from a current position of a host vehicle to a destination on a map when the destination has been set. When no destination is set, the route information may refer to information including a road on which the host vehicle is currently traveling and a future driving route including the road.

The operating unit 106 may be configured as a module that is controlled by the user for driving. For example, the operating unit 106 may be a steering wheel for manual driving, an automatic or manual shift transmission, an accelerator pedal, a brake pedal, or the like. The operating unit 106 may be further provided with an interface for enabling or disabling an autonomous driving mode and selecting detailed functions requested by the user so that the user may use an autonomous driving function. In order to receive various requests related to autonomous driving, the operating unit 106 may be configured, for example, as a hard-type interface provided at a predetermined position inside the vehicle 100, or as a soft-type interface that may be touched on the display 108. Depending on the specifications of the autonomous vehicle, at least one of the steering wheel, the transmission, and the pedal may be omitted. As another example, the operating unit 106 may be provided with a module that receives a user's control request for the load device 114 in addition to driving control.

The display 108 may function as a user interface. The display 108 may output and display an operating state, a control state, route/traffic information, remaining energy amount information, content requested by the driver, or the like, of the vehicle 100 by the processor 130. In addition, the display 108 may be configured as a touch screen capable of detecting a driver's input to receive a driver's request to instruct the processor 130.

The load device 114 may be mounted on the vehicle 100 and may be a type of non-driving electrical device excluding a driving power system such as the wheel driving unit 118 or the like. The load device 114 may be an auxiliary device that receives electrical power from the energy generating unit 110, and may be, for example, an air conditioning system, a lighting system, a seat system, various devices installed in the vehicle 100, or the like. In the present disclosure, a cooling/heating system that cools or heats at least one of a battery, a fuel cell, an internal combustion engine, an air conditioning system, and a specific part of the vehicle 100 may be further included.

The transmitting/receiving unit 112 may support mutual communication with the server 200, the ITS device 300, the surrounding vehicles 400, or the like. The transmitting/receiving unit 112 may include a module that processes, for example, cellular communication, WAVE, DSRC communication, and the like. In the present disclosure, the transmitting/receiving unit 112 may transmit data generated or stored while driving to the server 200 and receive data and software modules transmitted from the server 200. The transmitting/receiving unit 112 may support communication with an electronic device carried by an occupant inside the vehicle 100. In embodiments of the present disclosure, the vehicle 100 may transmit and receive data utilized in a method according to the embodiments of the present disclosure to and from the outside through the transmitting/receiving unit 112.

For example, the transmitting/receiving unit 112 may receive traffic signal information from a traffic signal controller and may provide the traffic signal information to the processor 130. In addition, the transmitting/receiving unit 112 may receive a control signal from the traffic signal controller and may provide the control signal to the processor 130.

In an embodiment, the operating unit 106, the display 108, and the transmitting/receiving unit 112 constitute an may audio/video/navigation/telecommunication (AVNT) device 150.

In addition, the vehicle 100 may include the energy generating unit 110 and the actuating unit 116.

The energy generating unit 110 may generate and supply power and electric power used in a driving power system and a non-driving power system, such as the actuating unit 116. The non-driving power system may be, for example, the sensor unit 102, the operating unit 106, the display 108, the load device 114, and the transmitting/receiving unit 112, but is not limited thereto, and may include various components that implement sensing, interface, communication, and convenience functions, excluding components directly involved in driving operations. In an embodiment in which the vehicle 100 is driven based on electrical energy, the energy generating unit 110 may be configured as an electric battery charged from the outside, or configured as a combination of an electric battery and a fuel cell that charges the electric battery. In the case of the combination of the electric battery and the fuel cell, the energy generating unit 110 may include a tank that stores materials used to produce electric power for the fuel cell, such as liquefied hydrogen. In an embodiment in which the vehicle 100 is driven based on fossil energy, the energy generating unit 110 may be configured as an internal combustion engine. In addition, in an embodiment in which the vehicle 100 is a hybrid type, the energy generating unit 110 may be provided as a combination of the internal combustion engine and the electric battery.

The actuating unit 116 may be provided with at least one module that implements driving operations and perform at least one driving operation among longitudinal control such as acceleration and deceleration and lateral control such as steering, according to a user request from the operating unit 106. In order to perform driving operations according to a command of the processor 130 by manual operation of the user or autonomous driving, the actuating unit 116 may be provided with the wheel driving unit 118 and mechanical components and electronic modules for implementing the driving operations in the wheel driving unit 118. When the vehicle 100 is operated based on electrical energy, the actuating unit 116 may include an assembly for transmitting the requested driving operation to the wheel driving unit 118. When the vehicle 100 is operated based on fossil energy, the actuating unit 116 may be provided with a transmission and a gear module that transmit the power of the internal combustion engine.

The wheel driving unit 118 may include a plurality of wheels, a driving force generation module for generating a driving force and applying the driving force to the wheels or transmitting the driving force, a braking module for slowing down the driving of the wheels, and a steering module for carrying out lateral control of the wheels. When the vehicle 100 is driven based on electrical energy, the driving force generating module may be configured as a motor assembly that generates a driving force based on electric power output from the electric battery. The braking module of the electric-based vehicle 100 may further have a regenerative braking function.

A navigation unit 122 may provide navigation information. The navigation information may include at least one of map information, set destination information, route information according to a set destination, information on various objects on the route, lane information, or current vehicle position information.

The navigation unit 122 may receive information from an external device through the transmitting/receiving unit 112 and update previously stored information. According to the embodiment, the navigation unit 122 may be classified as a sub-component of the operating unit 106.

The memory 120 may store applications and various types of data for controlling the vehicle 100. The memory 120 may load applications or read and record data by a request of the processor 130.

The processor 130 may perform overall control of the vehicle 100. The processor 130 may be configured to execute applications and computer-readable instructions stored in the memory 120. In an embodiment, the processor 130 may control operation of the vehicle 100, such as speed of the vehicle 100, route taken by the vehicle 100, lane changes by the vehicle 100, acceleration and/or deceleration of the vehicle 100, etc., based on the improved object recognition as described herein.

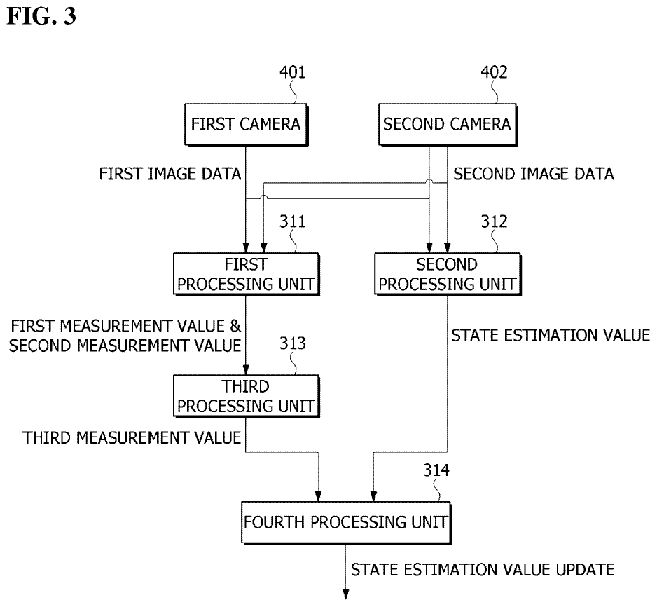

FIG. 3 is a diagram for describing the operation of an object detection device 300 according to an embodiment. Referring to FIG. 3, the object detection device 300 according to the embodiment may include a processor 310 and a memory 320. The memory 320 and the processor 310 of the object detection device 300 may have the same or similar configuration as the memory 120 and the processor 130 in FIG. 2.

The processor 310 may include a first processing unit 331, a second processing unit 312, a third processing unit 313, and a fourth processing unit 314.

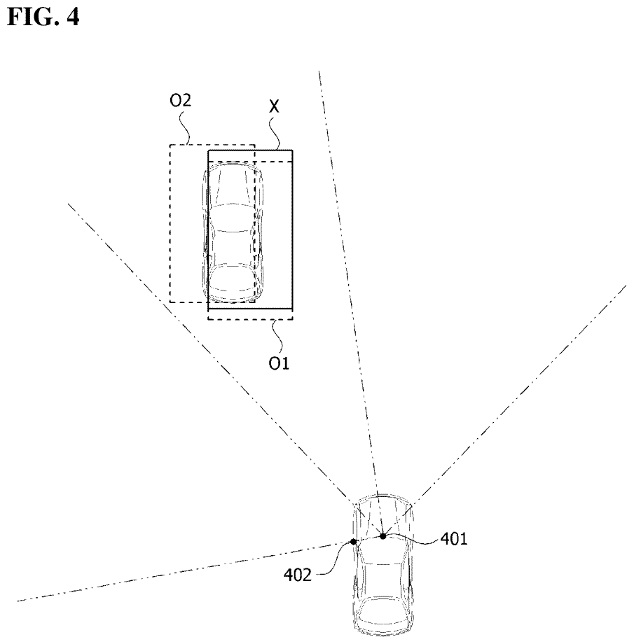

Referring also to FIG. 4, the first processing unit 311 may detect an object O in first image data captured by a first camera 401 to calculate a first measurement value O₁, and may detect an object in second image data captured by a second camera 402 to calculate a second measurement value O₂. In an embodiment, the measurement values may include information about the location, speed, and acceleration of the object. In FIG. 4, X is a state estimation value, described in more detail below.

The first processing unit 311 may extract center coordinates of an object from each frame of image data. The coordinates represent a location that the object occupies within an image. The first processing unit 311 may calculate a speed using location information. The speed may be defined as a change in location over a time interval, and through the speed, a velocity vector in each direction may be calculated. In addition, the first processing unit 311 may compute an acceleration using the change in speed over a time interval.

For example, the first processing unit 311 may detect outlines of objects in the image data, compare the detected outline with an appearance of an object stored in advance in the memory 320. The first processing unit 311 may detect an object having an outline that matches the appearance of the object stored in advance. In this case, the appearance of the object stored in the memory 320 may be the appearances of one or more objects, and the first processing unit 311 may detect the object having the matching outline as the object as described above and determine the type of the object at the same time.

In addition, for example, the first processing unit 311 may extract feature points of the object in the image data, and may detect the object in the image data as the object when the extracted feature points match feature points of the object stored in advance in the memory 320 with a proximity equal to or greater than a threshold value. In this case, the first processing unit 311 may use the scale invariant feature transform (SIFT) or speeded up robust features (SURF) algorithm, for example, to extract feature points from images of two objects to be compared and match feature point descriptors of the two extracted objects.

In addition, for example, the first processing unit 311 may detect objects based on the outlines of the objects in the image data. For example, the first processing unit 311 may detect the outlines of the objects in image data to generate an edge image, may detect the outlines from foreground image data that is a background image stored in advance in the memory 320 to generate a background edge image, and may detect objects in a different image obtained by subtracting the background edge image from the edge image. In an embodiment, the first processing unit 311 detects an outline of an object appearing within a frame as an edge using gradient information of the image data frame to generate the edge image. In an embodiment, the gradient information is a value generated from a difference value between adjacent pixels among certain pixels in a frame, and refers to the sum of absolute values of the differences, and the edge refers to a boundary line between objects using the gradient information.

In addition, the first processing unit 311 may detect an edge of an object corresponding to the background from image data of the foreground within a road that has been previously photographed to generate the background edge image. The background edge image may be an image in which the outlines of objects in a preset area are detected as background edges. For example, the image may be an image obtained by detecting the outline of an object that appears the same repeatedly a certain number of times or more when a plurality of image data frames of the foreground within the road that has been previously photographed are compared as the background edge.

In addition, the first processing unit 311 may detect objects in the image data using an object detection classifier. In this case, the object detection classifier is trained by constructing a training database (DB) from images of objects that have been previously photographed with different poses or external environments of the objects, and this object detection classifier generates an object DB through various learning algorithms including a support vector machine (SVM), a neural network, and the AdaBoost algorithm. In an example, the first processing unit 311 may detect the object by detecting an edge of an object corresponding to the foreground from image data of the background within the road that has been previously photographed, applying the edge of the foreground object detected in the image data, and applying an object detection classifier to an area of image data to which the edge of the foreground object is applied.

In addition, the first processing unit 311 may reduce noise in image data captured by a photographing unit 111 and may perform image signal processing to improve image quality, such as gamma correction, color filter array interpolation, color matrix, color correction, color enhancement, and the like. The first processing unit 311 may also perform color processing, blur processing, edge emphasis processing, image interpretation processing, image recognition processing, image effect processing, or the like.

The first processing unit 311 may generate operation data representing the movement of a dynamic object among a plurality of objects using the image data. The first processing unit 311 may detect the movement at a specific point, a specific object, or a specific pixel on a distribution map using a single piece of image data or a plurality of consecutive pieces of image data.

The first processing unit 311 may, for example, generate first operation data representing the movement of a dynamic object among a plurality of objects using the first image data. The first processing unit 311 may also generate second operation data representing the movement of a dynamic object among a plurality of objects using the second image data.

The first processing unit 311 may detect the movement of the dynamic object using a dense optical flow method. The first processing unit 311 may detect the movement for each pixel by computing a motion vector for all pixels on the image data.

The first processing unit 311 may detect the movement of the dynamic object using a sparse optical flow method. The first processing unit 311 may detect the movement by computing motion vectors only for some characteristic pixels, such as an edge in an image, for which movement following is easy.

Alternatively, the first processing unit 311 may detect the movement of the dynamic object using the Block Matching. The first processing unit 311 may detect the movement by dividing the image evenly or unevenly and computing a motion vector for the divided area.

Alternatively, the first processing unit 311 may detect the movement of the dynamic object using a continuous frame difference method. The first processing unit 311 may detect the movement by comparing consecutive image frames pixel by pixel and computing a value corresponding to the difference.

Alternatively, the first processing unit 311 may detect the movement of the dynamic object using a background subtraction method. The first processing unit 311 may detect the movement by comparing consecutive image frames pixel by pixel in a state where the background image has been initially learned and computing a value corresponding to the difference.

The first processing unit 311 may detect the movement on the distribution map using an appropriate method according to a road environment and external settings.

In an embodiment, the first camera 401 and the second camera 402 are disposed at different locations to capture the exterior of the vehicle. The fields of view (FOV) of the first camera 401 and the second camera 402 may overlap in a predetermined area.

In an embodiment, the object may include a dynamic object and a static object. The static object may include a road sign, a traffic light, a lane line, a road boundary, a building, a guardrail, a barrier, a crosswalk and stop line, a tunnel, a bridge, and the like. The dynamic object may include another vehicle, a pedestrian, a bicycles, a scooter, an animal, and other moving obstacles.

The first camera 401 may be a camera that photographs the front area of the vehicle, and the second camera 402 may be a camera that photographs the left side and the left front side of the vehicle. The first camera 401 and the second camera 402 may have the fields of view that overlap in a predetermined area in a certain area of the left front of the vehicle. The third vehicle may refer to the dynamic object O located within the overlapped field of view of the first camera 401 and the second camera 402 in the left front area of the host vehicle.

In the following embodiment, the object is described as another vehicle located within the overlapped field of view of the first camera 401 and the second camera 402, as an example.

The first measurement value and the second measurement value may include probability information that the object is present at specific coordinates and distance information.

The first processing unit 311 may calculate a confidence (conf) indicating the possibility that the object is present in a specific pixel of image data to calculate the probability information expressed as a probability value. The probability information represents a possibility that an arbitrary pixel is a portion of the object.

When a probability value exceeds a preset threshold value, the first processing unit 311 may determine that the corresponding pixel includes the object.

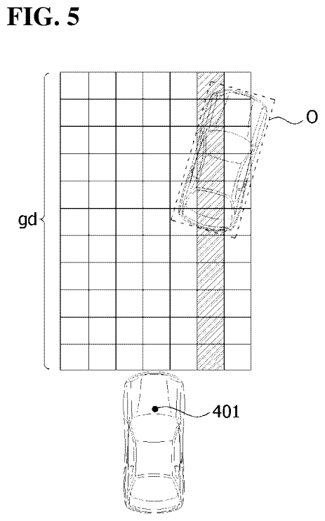

The first processing unit 311 may calculate a depth vector expressing distance information about the object. Referring also to FIG. 5, the distance information represents a distance (depth) ga between each object and a camera, and this depth vector may be defined based on a forward axis based on the host vehicle. The distance information may express how far the object O is from the camera 401.

The first processing unit 311 may estimate a probability that another vehicle is located and grid-based depth (distance) information using image data of the camera. The first processing unit 311 may extract probability information and distance information by extracting 3D spatial information utilizing a computer vision model and a deep learning model.

The first processing unit 311 may recognize the object from pixel data of the image data acquired from the camera. The first processing unit 311 may recognize the object using an object detection algorithm (e.g., YOLO, Faster R-CNN, SSD, or the like) and a deep learning-based object detection model.

The first processing unit 311 may calculate the probability that the object is present at a specific location in the image data to classify the corresponding area. The first processing unit 311 may generate a bounding box of the object and specify the location of each object in the image data. For example, the first processing unit 311 may express the coordinates of the object as (x_min, y_min, x_max, y_max).

The first processing unit 311 may calculate the distance information using a monocular depth estimation method. The first processing unit 311 may predict a depth value for each pixel of the image data using a pre-trained deep learning model (e.g., Monodepth2, DPT, or the like).

In addition, the first processing unit 311 may calculate the distance information using the size of the object and a positional relationship on the road. For example, the first processing unit 311 may estimate a relative distance by comparing the size of the vehicle and a change in pixel size at a specific location.

Alternatively, when the first camera 401 and the second camera 402 are stereo cameras, the first processing unit 311 may estimate the depth using a disparity between the two images. The first processing unit 311 may measure a difference in location of the same object in images captured from two cameras. The first processing unit 311 may calculate the depth using disparity information. The larger the disparity, the closer the object is, and the smaller the disparity, the further away the object is.

Alternatively, the first processing unit 311 may calculate absolute distance information through triangulation using the disparity and the distance between the cameras (base distance).

The first processing unit 311 may divide an environment in which the vehicle is traveling into 3D spaces in a grid format and generate depth information for each grid cell. The first processing unit 311 may divide the environment in front of the vehicle into grid cells of a specific size and express each cell to represent an actual space on the road. Each cell is mapped to pixels of a corresponding area.

The first processing unit 311 may assign previously estimated depth (distance) information to each grid cell. For example, the first processing unit 311 may average the depths of all pixels located within a specific grid cell or take a minimum depth and assign the minimum depth as the depth value of the cell.

The first processing unit 311 may calculate a probability that the vehicle is present in the specific grid by reflecting probability information obtained from the object detection model. For example, when a bounding box of the vehicle recognized as an object detection result overlaps with the specific grid, the first processing unit 311 may assign a high probability that the vehicle is present in the grid cell.

The distance information and probability information about each grid calculated as described above may be included in the first measurement value and the second measurement value, respectively.

The image data is generated in frame units from the first camera 401 and the second camera 402, and the first processing unit 311 may calculate the depth information and probability information about each grid for each consecutive frame while maintaining temporal consistency.

The second processing unit 312 may estimate the movement of the object from the first image data and the second image data to calculate a state estimation value. The second processing unit 312 may calculate the state estimation value by reflecting the movement of the host vehicle.

The second processing unit 312 may calculate the state estimation value using a Kalman filter. The second processing unit 312 may be set to reflect the speed and acceleration of the host vehicle in a state vector of the Kalman filter so that the speed and acceleration may be reflected in predicting the state of other vehicles.

For example, the second processing unit 312 may define a three-dimensional state vector x_{target} including the location, speed, and acceleration of other vehicles according to the following Equation 1. In Equation 1, x_{target}, y_{target}, and z_{target} are location coordinates of other vehicles.

$${X}_{target} = [ \begin{matrix}{x}_{target} \\ {y}_{target} \\ {z}_{target} \\ {\dot{x}}_{target} \\ {\dot{y}}_{target} \\ {\dot{z}}_{target} \\ {\ddot{x}}_{target} \\ {\ddot{y}}_{target} \\ {\ddot{z}}_{target}\end{matrix} ] \qquad [ Equation 1 ]$$

The second processing unit 312 may define a three-dimensional state vector x_{ego} including the location, speed, and acceleration of the host vehicle using the vehicle driving information of the second sensor unit according to the following Equation 2. In Equation 1, x_{ego}, y_{ego}, and z_{ego} are location coordinates of the host vehicle.

$${X}_{ego} = [ \begin{matrix}{x}_{ego} \\ {y}_{ego} \\ {z}_{ego} \\ {\dot{x}}_{ego} \\ {\dot{y}}_{ego} \\ {\dot{z}}_{ego} \\ {\ddot{x}}_{ego} \\ {\ddot{y}}_{ego} \\ {\ddot{z}}_{ego}\end{matrix} ] \qquad [ Equation 2 ]$$

The second processing unit 312 may set a state transition equation based on a relative motion between the host vehicle and the other vehicles to predict the state of the other vehicles. Since the speed and acceleration of the host vehicle affect the relative location and speed of other vehicles, the second processing unit 312 may design an equation by considering the effect.

The second processing unit 312 may calculate relative locations xᵣₑₗ, x_{target} and x_{ego} and relative speeds \dot{x}ᵣₑₗ, \dot{x}_{target} and \dot{x}_{ego} of the host vehicle and the other vehicles as in the following Equation 3.

$${x}_{rel} = {x}_{target} - {x}_{ego} , {\dot{x}}_{rel} = {\dot{x}}_{target} - {\dot{x}}_{ego} \qquad [ Equation 3 ]$$

The second processing unit 312 may predict a next state of the other vehicles through the state transition equation based on the relative locations and relative speeds. The second processing unit 312 may calculate a location and speed of another vehicle according to the following Equation 4 by considering a time interval Δt.

$${X}_{target , t + 1} = {FX}_{target , t} + {BX}_{ego , t} + {w}_{t} \qquad [ Equation 4 ]$$

In Equation 4, F is a matrix representing the state transition of another vehicle, B is a matrix modeling the effect of the speed and acceleration of the host vehicle, and wₜ is noise.

In addition, X_{target,t+1} is a predicted state vector of another vehicle at time t+1, which means a state estimation value, X_{target,t} is a state vector of another vehicle at the current time t, and X_{ego,t} is a state vector of the host vehicle at the current time t.

The third processing unit 313 may calculate a third measurement value by integrating the first measurement value and the second measurement value.

The third processing unit 313 may initialize the distance information about the measurement value using a variance of the probability information and distance information. The distance information may refer to the depth vector.

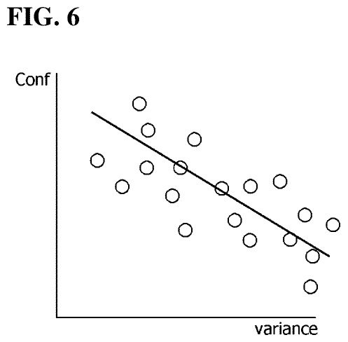

Referring also to FIG. 6, the third processing unit 313 may analyze a correlation between the probability information and distance information about the measurement value and dynamically adjust a covariance value for the distance information about the measurement value according to the confidence, thereby reflecting the tendency of network output. In FIG. 6, a Y-axis is the probability information about the measurement value, i.e., the confidence, and an X-axis is a variance of the distance information included in the measurement value. The third processing unit 313 may analyze the degree of effect of the confidence of the measurement value on the variance of the distance information as shown in a graph in FIG. 6, and it may be confirmed that as the confidence decreases, the variance of the distance information also decreases.

A method of initializing an error covariance of the depth vector in the Kalman filter indicates how well the initial prediction value of the filter matches the measurement value, and significantly affects the confidence of the initial state. The error covariance used in this process may act as an important factor for the filter to reflect the uncertainty about the depth of the object.

An error covariance matrix represents the uncertainty of an initial state estimation value. For a particular value, such as the depth vector, the larger the initial error covariance, the more weight the Kalman filter puts on a subsequent measurement value to perform updates, and the smaller the initial covariance, the more the filter trusts the initial state.

The third processing unit 313 may set the initial error covariance through the correlation between the probability information and the variance of the depth vector. The third processing unit 313 may set the uncertainty at a time point of filter initialization using the variance value calculated from the depth vector of the object as the initial covariance value.

For example, the third processing unit 313 may calculate a correlation coefficient r(Cᵢ,σ²) between the confidence of the object and the variance of the depth vector according to Equation 5 below.

$$r ( {C}_{i} , {σ}^{2} ) = \frac{{\sum }_{i = 1}^{N} ( {C}_{i} - \overline{C} ) ( {σ}_{i}^{2} - {\overline{σ}}^{2} )}{\sqrt{{\sum }_{i = 1}^{N} {( {C}_{i} - \overline{C} )}^{2} {\sum }_{i = 1}^{N} {( {σ}_{i}^{2} - {\overline{σ}}^{2} )}^{2}}} \qquad [ Equation 5 ]$$

In Equation 5, N is the total number of pieces of data, Cᵢ is a confidence value of each object,

$${σ}_{i}^{2}$$

is a depth variance value of the object, C̅ is an average of the confidence, and σ̅² is an average of the depth variance.

The third processing unit 313 may calculate a covariance initialization value based on a correlation coefficient between the confidence of the object and the variance of the depth vector according to the following Equation 6.

$${σ}^{2} = r ( {C}_{i} , {σ}^{2} ) \cdot {C}_{i} + b \qquad [ Equation 6 ]$$

In Equation 6, σ² is an initialization value of the depth covariance, and b is an intercept value of σ².

The third processing unit 313 may initialize the depth vector by calculating the covariance initialization value according to the aforementioned Equation 5 when the correlation coefficient between the confidence and the variance of the depth vector is equal to or greater than a preset reference value.

Alternatively, when the correlation coefficient between the confidence and the variance of the depth vector is less than the preset reference value, the third processing unit 313 may initialize the depth vector using data stored in the memory. For example, when the correlation coefficient is less than the reference value, the third processing unit 313 may set the initial covariance using a hash table having predefined variance values according to confidence values. The hash table may divide the confidence into sections and store a depth variance value corresponding to each section, and a corresponding variance value may be set as the initial covariance value according to the confidence section preset during the initialization. For example, the third processing unit 313 may divide the confidence having a value of 0 to 1 into sections with a range of 0.05, assign a covariance value corresponding to each section, and use the assigned covariance for the covariance initialization.

The third processing unit 313 may initialize the covariance of the depth vector based on the correlation coefficient when the correlation coefficient between the confidence of the object and the variance of the depth vector is high, and may initialize the covariance of the depth vector using the hash table based on the confidence when the correlation coefficient is not high.

The third processing unit 313 may compare the first measurement value and the second measurement value with the state estimation value to determine whether there is a match, and may calculate the third measurement value using at least one of the first measurement value and the second measurement value that is matched.

The third processing unit 313 may compare the first measurement value and the second measurement value for which initialization has been completed with the state estimation value to determine whether there is a match, and may calculate the third measurement value using at least one of the first measurement value and the second measurement value that is matched.

The third processing unit 313 may match the measurement value and the state estimation value (track), evaluate how well each measurement value corresponds to the predicted estimation value, and assign the measurement value to the most appropriate estimation value.

The third processing unit 313 may compare the first measurement value and the second measurement value with the state estimation value using the Hungarian algorithm to determine whether there is a match.

There are several possible combinations when matching the measurement value and the estimation value, and a matching cost is incurred for each combination. The Hungarian algorithm is an optimization algorithm that finds a matching combination that minimizes the total cost among all combinations. The third processing unit 313 uses the Hungarian algorithm to assign each measurement value to the most appropriate estimation value.

The matching cost is a numerical representation of the similarity between the estimation value and the measurement value and decreases as a difference between the predicted value and the measurement value decreases. The third processing unit 313 may apply a Mahalanobis distance and a yaw angle difference as the matching cost.

The third processing unit 313 may measure a distance between two points by considering a covariance using the Mahalanobis distance. The third processing unit 313 may evaluate how much each measurement value matches the predicted value, i.e., a suitability with the track, and may determine that the smaller the Mahalanobis distance, the more likely it is that the predicted value and the measurement value are information on the same object.

Alternatively, the third processing unit 313 may add a difference between the estimation value and the measurement value as a cost item under the assumption that the smaller a difference in a rotational state (direction) of the object, the higher the possibility that the object is the same object.

The third processing unit 313 may match the measurement value and the estimation value based on a cost matrix including a Mahalanobis distance and a yaw angle difference. The third processing unit 313 may select a combination with a low cost and ultimately assign each measurement value to the most appropriate estimation value.

The third processing unit 313 may calculate the third measurement value using the first measurement value and the second measurement value assigned to the estimation values through the Hungarian algorithm.

The third processing unit 313 may calculate normal distributions of the first measurement value and the second measurement value and calculate the third measurement value by integrating the calculated normal distributions.

The third processing unit 313 may calculate the third measurement value by reflecting weights in the first measurement value and the second measurement value according to the probability information.

The third processing unit 313 may reflect weights in the first measurement value and the second measurement value in proportion to the probability value of the probability information.

The third processing unit 313 may calculate the normal distributions of the first measurement value Oᵢ¹ and the second measurement value Oᵢ² according to the following Equation 7.

$${σ}_{i}^{1} \sim N ( {μ}_{1} , \sum 1 ) , {σ}_{i}^{2} \sim N ( {μ}_{2} , \sum 2 ) \qquad [ Equation 7 ]$$

In Equation 7, μ₁ and μ₂ are average values of the object of the first measurement value and the second measurement value, respectively, and Σ1 are Σ2 covariance matrices for respective measurement values and represent the uncertainties of values measured from the respective cameras.

The third processing unit 313 may generate a new joint distribution of the third measurement value through the product of two independent normal distributions. The third processing unit 313 may generate the joint distribution of the third measurement value according to the following Equation 8.

$${σ}_{i}^{′} = {σ}_{i}^{1} \cdot {σ}_{i}^{2} \sim N ( {μ}^{′} , {\sum }^{′} ) \qquad [ Equation 8 ]$$

The average μ′ and the covariance Σ′ of the third measurement value may be defined according to the following Equations 9 and 10.

$${μ}^{′} = {\sum }^{′} ( {\sum }_{1}^{- 1} {μ}_{1} + {\sum }_{2}^{- 1} {μ}_{2} ) \qquad [ Equation 9 ]$$

$${\sum }^{′} = {( {\sum }_{1}^{- 1} + {\sum }_{2}^{- 1} )}^{- 1} \qquad [ Equation 10 ]$$

Accordingly, the average of the third measurement value is biased toward a measurement value with lower covariance, and the covariance reflects the covariance of each measurement value to give a greater confidence to the measurement value with lower covariance.

The reason that in the third measurement values, a measurement value with lower covariance is given a greater weight is that the lower the covariance, the higher the confidence of the measurement value, and the covariance may be combined in proportion to the confidence of the two measurement values. Accordingly, the measurement value with lower covariance (i.e., a more accurate measurement value) has a greater effect on the third measurement value, which is reflected in both the average and covariance of the third measurement value, so that the more confident measurement value plays a dominant role in all measurement values.

In this way, the third measurement value may be integrated based on a value with higher confidence (a value with lower covariance) among the first measurement value and the second measurement value.

Alternatively, the third processing unit 313 may calculate the third measurement value using the first measurement value or second measurement value that is matched. When there is only one measurement value assigned to the estimation value through the Hungarian algorithm, the third processing unit 313 may calculate the third measurement value using the corresponding measurement value. In this case, the third processing unit 313 may set the corresponding measurement value as the third measurement value without a separate integration process. Accordingly, the third processing unit 313 may set the first measurement value as the third measurement value when the matched measurement value is the first measurement value, and may set the second measurement value as the third measurement value when the matched measurement value is the second measurement value.

The fourth processing unit 314 may update the state estimation value by reflecting the third measurement value in the state estimation value.

The fourth processing unit 314 may obtain a more accurate estimation value by correcting the predicted state based on an actual measurement value. The fourth processing unit 314 may combine the state estimation value and the third measurement value using a Kalman gain.

The Kalman gain is a weight that combines the predicted value and the measurement value, and may be determined by the error covariance and the measurement error covariance. The fourth processing unit 314 may calculate the Kalman gain according to the following Equation 11.

$$K = {P}_{k}^{T V} - {{H}^{T} ( {HP}_{k}^{T V} - {H}^{T} + R )}^{- 1} \qquad [ Equation 11 ]$$

In Equation 11, K is a Kalman gain and is a weight that determines how much to reflect the difference between the measurement value and the estimation value, and H^{T} is a transpose matrix of a measurement model matrix H. R is a covariance matrix of measurement noise. The Kalman gain may be reflected when reflecting the uncertainty between the predicted state and the measurement values to update a final state.

The fourth processing unit 314 may calculate a corrected state estimation value by combining the state estimation value and the third measurement value according to the following Equation 12 using the Kalman gain. In this case, a difference between the measurement value and the predicted value (a measurement residual or innovation value) is used.

$${\hat{x}}_{k} = {\hat{x}}_{k}^{-} + {K}_{k} \cdot ( {z}_{k} - H \cdot {\hat{x}}_{k}^{-} ) \qquad [ Equation 12 ]$$

In Equation 12,

$${z}_{k} - H \cdot {\hat{x}}_{k}^{-}$$

is a measurement residual or innovation value, and may refer to a difference between the third measurement value and the state estimation value. A large measurement residual value means that predictions significantly differ from measurements.

In Equation 12,

$${K}_{k} \cdot ( {z}_{k} - H \cdot {\hat{x}}_{k}^{-} )$$

is a parameter that adjusts the difference between the predicted value and the measurement value by multiplying the Kalman gain to the residual. A larger value of the parameter means that the measurement value is reflected more significantly in the state update.

The fourth processing unit 314 may update the error covariance representing the uncertainty for the new state estimation value. The fourth processing unit 314 may update the error covariance as in the following Equation 13 by reflecting the Kalman gain.

$${P}_{k} = ( I - {K}_{k} \cdot H ) \cdot {P}_{k}^{-} \qquad [ Equation 13 ]$$

In Equation 13, I is a unit matrix, and the fourth processing unit 314 makes a correction by reducing the error covariance to obtain a more accurate state estimation value. The corrected covariance may be used to calculate a state estimation value at a next time step.

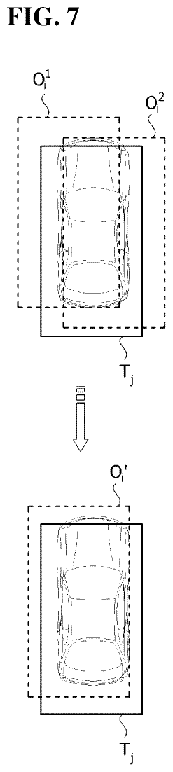

Referring also to FIG. 7, the processor may calculate a third measurement value Oᵢ³ by multiplying normal distributions of a first measurement value Oᵢ¹ and a second measurement value Oᵢ². The processor may update a state estimation value Tᵢ by reflecting the third measurement value Oᵢ³ in the state estimation value Tᵢ using the Kalman gain, thereby correcting the predicted state based on the actual measurement value to obtain a more accurate estimation value later.

In an embodiment, the processor 310 may control operation of the vehicle 100, such as speed of the vehicle 100, route taken by the vehicle 100, lane changes by the vehicle 100, acceleration and/or deceleration of the vehicle 100, etc., based on object recognition using the corrected predicted state, thereby improving control and operation of the vehicle 100.

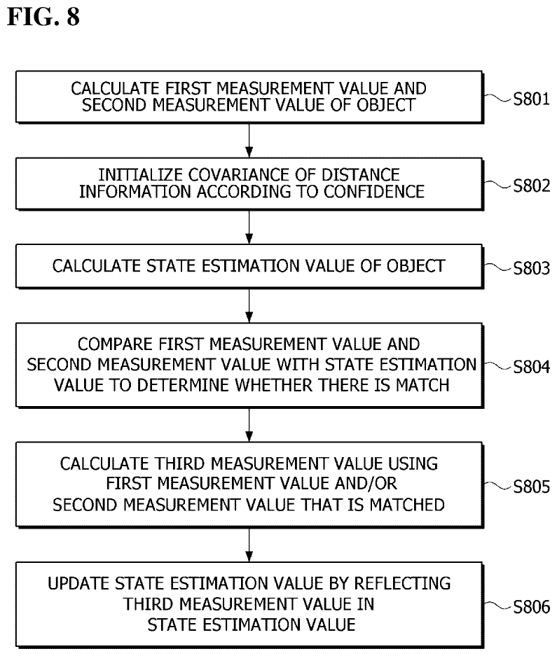

FIG. 8 is a flowchart of a method of detecting an object according to an embodiment. Referring to FIG. 8, in an operation S801, a processor (e.g., the processor 130 of FIG. 2 or the processor 310 of FIG. 3) detects an object in first image data captured by the first camera to determine (e.g., calculate) a first measurement value, and detects an object in second image data captured by the second camera to determine (e.g., calculate) a second measurement value.

In an operation S802, the processor initializes the covariance of distance information according to the confidence of the first measurement value and the second measurement value.

In an operation S803, the processor estimates the movement of the object from the first image data and the second image data and determines (e.g., calculates) a state estimation value. For example, the processor calculates the state estimation value by reflecting the movement of the host vehicle.

In an operation S804, the processor compares the first measurement value and the second measurement value whose covariances are initialized with the state estimation value to determine whether there is a match.

In an operation S805, the processor determines (e.g., calculates) a third measurement value based on (e.g., using) at least one of the first measurement value and second measurement value that is matched. For example, the processor calculates a third measurement value by reflecting weights in the first measurement value and the second measurement value according to probability information.

In an operation S806, the processor updates the state estimation value by reflecting the third measurement value in the state estimation value.

In an embodiment, the processor may control operation of a vehicle, such as speed of the vehicle, route taken by the vehicle, lane changes by the vehicle, acceleration and/or deceleration of the vehicle, etc., based on object recognition using the updated estimation value, thereby improving control and operation of the vehicle 100.

The term “˜unit” used in the present embodiment refers to software components or hardware components such as a field-programmable gate array (FPGA) or an application specific integrated circuit (ASIC), and “˜unit” performs certain functions. However, the “˜unit” is not limited to software or hardware. The “˜unit” may be configured to reside in an addressable storage medium, or may be configured to reproduce one or more processors. Therefore, for example, “˜unit” includes components such as software components, object-oriented software components, class components, and task components, and includes processes, functions, attributes, procedures, sub-routines, segments of program code, drivers, firmware, micro code, circuits, data, a database, data structures, tables, arrays, and variables. Functions provided in the components and the “˜unit” may be combined into smaller numbers of components and “˜units,” or may be further divided into additional components and “˜units.” Furthermore, the components and “˜units” may be implemented to reproduce one or more CPUs in a device or a security multimedia card.

With an object detection device and method according to an embodiment, it is possible to solve a problem of object overlap detection that occurs in a multi-camera system by improving a Kalman filter to converge duplicate estimation values into a single consistent estimation value.

In this way, when each camera recognizes the same object, it is possible to integrate the recognized object into a single estimation value through the Kalman filter, thereby improving the accuracy and consistency of object recognition.

In addition, it is possible to improve the accuracy and stability of Kalman filter estimation values.

Although several embodiments of the present disclosure have been described above, it should be understood by those having ordinary skill in the art may that various changes and modifications may be made without departing from the spirit and scope of the present disclosure set forth in the claims below.

What is claimed is:

1. An object detection device comprising:
one or more processors; and
a memory storing computer-readable instructions executable by the one or more processors,
wherein the one or more processors is configured to:
detect an object in first image data captured by a first camera to determine a first measurement value,
detect the object in second image data captured by a second camera to determine a second measurement value,
estimate movement of the object from the first image data and the second image data to determine a state estimation value,
determine a third measurement value based on the first measurement value and the second measurement value, and
update the state estimation value by reflecting the third measurement value in the state estimation value.

2. The object detection device of claim 1, wherein the one or more processors are configured to determine the state estimation value by reflecting movement of a host vehicle.

3. The object detection device of claim 2, wherein the one or more processors are configured to:
compare the first measurement value and the second measurement value with the state estimation value to determine whether there is a match; and
determine the third measurement value using at least one of the first measurement value and the second measurement value that is matched.

4. The object detection device of claim 3, wherein the one or more processors are configured to compare the first measurement value and the second measurement value with the state estimation value using a Hungarian algorithm to determine whether there is a match.

5. The object detection device of claim 1, wherein the one or more processors are configured to:
determine normal distributions of the first measurement value and the second measurement value; and
determine the third measurement value by integrating the normal distributions.

6. The object detection device of claim 5, wherein the one or more processors are configured to determine the third measurement value by reflecting weights in the first measurement value and the second measurement value according to probability information.

7. The object detection device of claim 6, wherein the one or more processors are configured to reflect the weights in the first measurement value and the second measurement value in proportion to a probability value of the probability information.

8. The object detection device of claim 1, wherein the first measurement value and the second measurement value include probability information that the object is present at specific coordinates and distance information.

9. The object detection device of claim 5, wherein the one or more processors are configured to initialize the first measurement value and the second measurement value using a variance of the probability information and the distance information.

10. The object detection device of claim 9, wherein the one or more processors are configured to:
compare the initialized first measurement value and second measurement value with the state estimation value to determine whether there is a match; and
determine the third measurement value using at least one of the first measurement value and the second measurement value that is matched.

11. A method of detecting an object, the method comprising:
detecting, by a processor, an object in first image data captured by a first camera to determine a first measurement value;
detecting, by the processor, the object in second image data captured by a second camera to determine a second measurement value;
estimating, by the processor, movement of the object from the first image data and the second image data to determine a state estimation value;
determining, by the processor, a third measurement value based on the first measurement value and the second measurement value; and
reflecting, by the processor, the third measurement value in the state estimation value to update the state estimation value.

12. The method of claim 11, wherein determining the state estimation value includes reflecting movement of a host vehicle.

13. The method of claim 12, wherein determining the third measurement value includes:
comparing the first measurement value and second measurement value with the state estimation value to determine whether there is a match; and
determining the third measurement value using at least one of the first measurement value and the second measurement value that is matched.

14. The method of claim 13, wherein determining whether there is a match includes comparing the first measurement value and the second measurement value with the state estimation value using a Hungarian algorithm.

15. The method of claim 11, wherein the first measurement value and the second measurement value include probability information that the object is present at specific coordinates and distance information.

16. The method of claim 15, wherein determining the third measurement value includes:
determining normal distributions of the first measurement value and the second measurement value; and
determining the third measurement value by integrating the normal distributions.

17. The method of claim 16, wherein determining the third measurement value includes determining the third measurement value by reflecting weights in the first measurement value and the second measurement value according to the probability information.

18. The method of claim 17, wherein determining the third measurement value includes reflecting the weights in the first measurement value and the second measurement value in proportion to a probability value of the probability information.

19. The method of claim 15, wherein determining the third measurement value includes initializing the first measurement value and the second measurement value using a variance of the probability information and the distance information.

20. The method of claim 19, wherein determining the third measurement value includes:
comparing the initialized first measurement value and second measurement value with the state estimation value to determine whether there is a match; and
determining the third measurement value using at least one of the first measurement value and the second measurement value that is matched.
